(19) United States
(12) Patent Application Publication
(10) Pub. No.: US 2024/0360566 A1
(43) Pub. Date: Oct. 31, 2024

(54) PRODUCTION OF GRAPHENE BY ELECTROCHEMICAL EXFOLIATION

(71) Applicant: Avadain LLC, Eads, TN (US)

(72) Inventors: William J. Grieco, Melbourne, FL (US); Michael A. Miller, Helotes, TX (US); John R. Hemmerling, San Antonio, TX (US)

(21) Appl. No.: 18/645,995

(22) Filed: Apr. 25, 2024

Related U.S. Application Data
(60) Provisional application No. 63/461,977, filed on Apr. 26, 2023.

(51) Int. Cl. C25B 1/135; C01B 32/19; C01B 32/225

(52) U.S. Cl. CPC C25B 1/135; C01B 32/19; C01B 32/225

(57) ABSTRACT

A method for the continuous production of graphene. The method includes flowing a suspension of graphite particles into a conductive, open-cell porous material that is disposed within a reaction vessel, applying a cathodic potential to the conductive, open-cell porous material, wherein the cathodic potential suffices to exfoliate graphene, and flowing a suspension of the exfoliated graphene out from the conductive, open-cell porous material.

### CROSS-REFERENCE TO RELATED APPLICATION

The present application claims the benefit of U.S. Provisional Application No. 63/461,977, filed on Apr. 26, 2023, the contents of which are incorporated by reference herein in their entirety.

### STATEMENT REGARDING FEDERALLY SPONSORED RESEARCH OR DEVELOPMENT

This invention was made with government support under “Scale-up of Continuous Manufacturing and Productization of Graphene for Advanced Respirator and Biosensor Applications,” #2970576300-01 awarded by the National Institute of Standards and Technology (NIST). The government has certain rights in the invention.”

### TECHNICAL FIELD

This invention relates to the electrochemical exfoliation of graphite for the production of graphene flakes.

### BACKGROUND

Idealized graphene is an infinitely large, defect-free 2-dimensional material of monoatomic thickness and crystalline order composed of sp² hybridized carbon atoms arranged in a hexagonal lattice. As a practical matter, real-world graphene has a finite size, is not defect-free, and generally includes multiple stacked layers. Nevertheless, the physical properties of real-world graphene can approach the physical properties of idealized graphene.

Graphite is a three-dimensional structure that generally includes thousands of graphene sheets stacked on top of one another in an ordered sequence held in place by weak van der Waals interactions. In some instances, the area of each graphene sheet in a graphite particle is comparable to the area defined by two dimensions of the particle, with the third dimension of the particle reflecting the number of stacked graphene sheets. In other words, the entire graphite particle can be a single crystal, although this is not necessarily the case.

Graphene can be produced by a variety of different techniques, including electrochemical exfoliation. For example, well-established methods of producing graphene that do not involve electrochemical exfoliation include epitaxial growth on catalytic substrates at high temperature, chemical vapor deposition (CVD), micromechanical exfoliation, and direct sonication. These methods have significant disadvantages when compared with the potential attributes of electrochemical exfoliation, including low product yield and practical barriers to large-scale production.

As for electrochemical exfoliation, some approaches apply oxidizing chemical solutions or anodic potentials to graphite. These approaches yield an at least partially-oxidized form of graphene known as graphene oxide (GO). Although graphene oxide can be produced in relatively large quantities and is commercially available, its physical properties differ from the physical properties of idealized graphene due to the oxygen impurities and mixture of sp² and sp³ hybridized carbon. Oxygen can be removed from graphene oxide via chemical reduction or thermal processing to form graphene with improved physical properties. However, removing the oxygen requires additional processing steps, at increased cost and energy consumption. Also, oxygen removal is more difficult than the removal of hydrogen from a hydrogenated graphene.

Other approaches to electrochemical exfoliation apply a high cathodic potential (e.g., −60 V) to graphite in an electrochemical cell. The cell generally contains a liquid electrolyte solution of an organic solvent and a supporting electrolyte salt and the anode is at an equally high anodic potential during exfoliation. The electrolyte composition aids exfoliation. Large ionic radii salts that are soluble in the electrolyte solvent intercalate between the stacked sheets of graphite and the applied potential drives cations of the electrolyte salt and those generated from the solvent at the anode to intercalate into the interlayer space of graphite. Gaseous species are formed in the interlayer space and further expand and exfoliate graphene sheets. In general, the exfoliated graphene is hydrogenated in that hydrogen atoms are bound to the defects. Thermal dehydrogenation—which occurs under relatively mild conditions—can be used to remove the defects and make the physical properties of the product closer to those of idealized graphene.

Examples of such approaches are found in WO 2021/048089 and the publication entitled “High Voltage Electrochemical Exfoliation of Graphite for High-Yield Graphene Production” (RSC Adv. 2019, 9 (50), p. 29305-29311, doi.org/10.1039/C9RA04795F), the contents of both of which are incorporated herein by reference.

### SUMMARY

Systems for the production of graphene flakes by electrochemical exfoliation and techniques for their continuous production are described.

In one aspect, a method for the continuous production of graphene includes flowing a suspension of graphite particles into a conductive, open-cell porous material that is disposed within a reaction vessel, applying a cathodic potential to the conductive, open-cell porous material, wherein the cathodic potential suffices to exfoliate graphene, and flowing a suspension of the exfoliated graphene out from the conductive, open-cell porous material.

This and other aspects can include one or more of the following features. A membrane can be fit to an outer surface of the conductive, open-cell porous material tightly enough to prevent establishment of a flow path for the graphite particles that does not pass through the conductive, open-cell porous material. The membrane can permit transport of the electrolyte salt but hinders or prevent transport of the exfoliated graphene and can be disposed between the conductive, open-cell porous material and an anode during the application of the cathodic potential. The membrane can have an average pore size of between 0.5 and 1 μm. An anode that includes multiple members can be in electrical contact with fluid in the reaction vessel. The members can be spatially distributed about the conductive, open-cell porous material. A residence time of material within the conductive, open-cell porous material can be between 1 and 600 minutes. Pores in the porous backbone material can be generally between 3 and 25 times larger, or between 5 and 10 times larger than a Sauter mean diameter of the graphite particles. The porous backbone material can have a void volume in excess of 50%, for example, in excess of 75%. The porous backbone material can be reticulated vitreous carbon foam. The cathodic potential can be applied relative to a doped-diamond anodic electrode. The cathodic potential can be in excess of −40 volts. An average largest dimension of pores in the conductive, open-cell porous material can be between 0.5-2 mm and the graphite particles have mean diameters ranging between 0.5 and 500 micrometers. The graphite particles can be suspended in propylene carbonate. The method can further comprise flowing an exfoliation solution that comprises an organic solvent and a supporting electrolyte salt into the reaction vessel. The organic solvent can be propylene carbonate, ethylene carbonate, or dimethyl carbonate. The electrolyte salt can be tetrabutylammonium hexafluorophospate, tetrabutylammonium hexafluoroborate, tetrabutylammonium bis(trifluromethanesulfonyl)imide, or N-benzyl-N,N,N-trimethylammonium hexafluorophosphate. The method can further comprise flowing reaction by-products out from the reaction vessel via an outlet that differs from an outlet via which the suspension of the exfoliated graphene flows out from the reaction vessel. The method can further comprise flowing the exfoliated graphene out from the reaction vessel and flowing a liquid that carries the exfoliated graphene out from the reaction vessel into a second conductive, open-cell porous material, and applying a cathodic potential to the second conductive, open-cell porous material, wherein the cathodic potential suffices to exfoliate graphene. The method can further comprise separating exfoliated graphene from the liquid that carries the exfoliated graphene out from the reaction vessel before flowing the liquid into the second conductive, open-cell porous material.

In another aspect, an electrochemical reactor is for the production of graphene. The reactor comprises an anode, a reticulated vitreous carbon foam cathode, and a membrane disposed between the reticulated vitreous carbon foam cathode and the anode. The membrane is configured to prevent transport of graphite particles but permit transport of electrolytes and organic solvent of a solution for exfoliation of graphite.

This and other aspects can include one or more of the following features. The membrane can be fit close enough to an outer surface of the cathode to prevent the establishment of flow paths for graphite particles that do not pass through the cathode. The membrane can be in contact with an outer surface of the cathode. The electrochemical reactor can further comprise a graphite suspension inlet fluidically coupled to provide suspended graphite particles to the cathode. The electrochemical reactor can further comprise an active control configured to control a parameter of electrochemical exfoliation of graphene.

The average largest dimension of pores in the reticulated vitreous carbon foam can be between 0.5-2 mm. The electrochemical reactor can further comprise a suspension of graphite particles and a pump configured to pump the suspension of graphite particles through the reticulated vitreous carbon foam cathode. A residence time of the pumped suspension within the reticulated vitreous carbon foam can be between 1 and 600 minutes.

The details of one or more implementations are set forth in the accompanying drawings and the description below. Other features, objects, and advantages will be apparent from the description and drawings, and from the claims.

### DESCRIPTION OF DRAWINGS

FIG. 1 is a schematic representation of an electrochemical reactor that can be used in the continuous production of graphene flakes by electrochemical exfoliation.

FIG. 2 is a schematic cross-section illustration of the electrochemical reactor of FIG. 1 along section 2-2.

FIG. 3 is a schematic partial cut-away view of a portion of the reaction vessel of the electrochemical reactor of FIG. 1.

FIG. 4 is a schematic representation of an example porous backbone material that can be used to form a cathode in an electrochemical reactor.

FIG. 5 is a schematic representation of an electrochemical reactor system that can be used in the continuous production of graphene flakes by electrochemical exfoliation.

Like reference symbols in the various drawings indicate like elements.

### DETAILED DESCRIPTION

As discussed above, the application of high cathodic potentials to graphite in an electrochemical cell can exfoliate graphene sheets that can be processed to have material properties that resemble those of idealized graphene.

However, these methods rely upon ongoing intimate electrical contact between the cathode and the graphite. If intercalation and separation happens to occur at an intermediate location in a graphite particle (i.e., away from a surface of the particle), electrical contact to a portion of the particle may be lost. Indeed, the graphite particle may simply break into particles that—without further exfoliation—retain their graphitic physical properties.

This issue can be addressed by mechanically compressing an aggregate of graphite particles or a thin disk of graphite to ensure that electrical contact is maintained and that exfoliation can proceed over as large a fraction of the graphite as possible. Typically, the compression constrains the graphite feedstock to a batch processing with a two-dimensional form factor as a planar aggregate or disk of graphite is compressed, thereby limiting scalability and complicating continuous production.

FIG. 1 is a schematic representation of an electrochemical reactor 100 that can be used in the continuous production of graphene flakes by electrochemical exfoliation. In the illustrated implementation, reactor 100 includes a reaction vessel 105, a graphite particle suspension inlet 110, an exfoliation solution inlet 115, a graphene suspension outlet 120, an exfoliation solution outlet 125, and anodic and cathodic lead connections 130, 135. During operation, exfoliation solution and a suspension of graphite particles can be supplied to reaction vessel 105 of reactor 100 through inlets 110, 115. Bias applied to an anode and cathode within reaction vessel 105 via anodic and cathodic lead connections 130, 135 drives the exfoliation of graphene. The exfoliated graphene and spent exfoliation solution and other by-products exit reaction vessel 105 through outlets 120, 125.

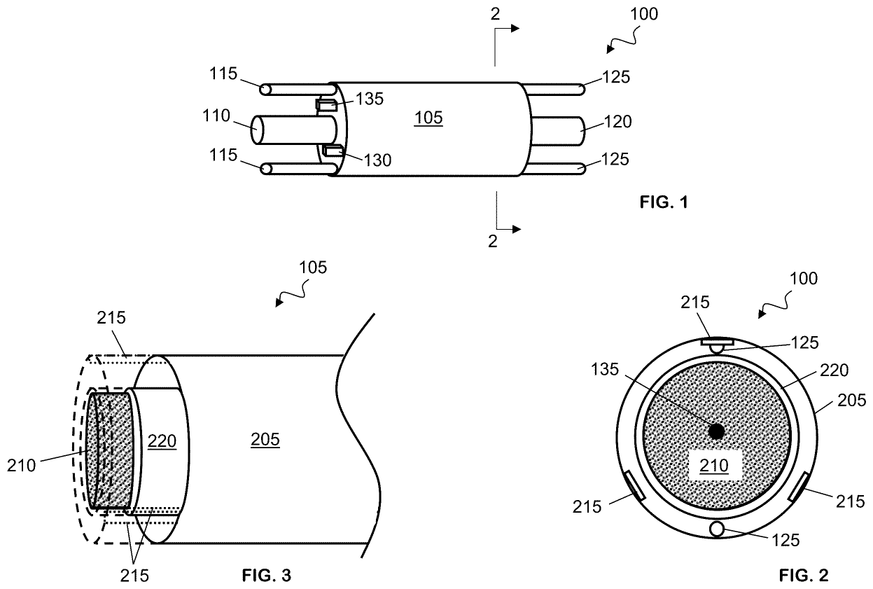

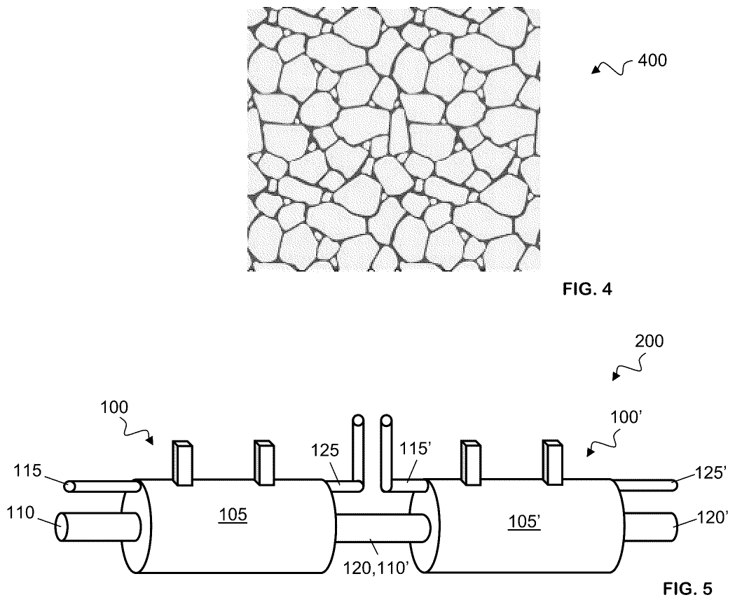

FIG. 2 is a schematic cross-section illustration of electrochemical reactor 100 along section 2-2 of FIG. 1. FIG. 3 is a schematic partial cut-away view of a portion of reaction vessel 105. Referring now to FIGS. 1-3, reaction vessel 105 includes a vessel wall 205 that defines the electrochemical cell for the exfoliation reaction. The electrochemical cell includes a cathode 210 and an anode 215 that are separated by a membrane 220. Graphite suspension inlet 110 is coupled to provide suspended graphite particles to cathode 210. As discussed further below, the graphite particles and exfoliated graphene are confined by membrane 220 to flow along cathode 210 from inlet 110 to outlet 120. Exfoliation solution inlet 115 is coupled to provide exfoliation solution to the volume between membrane 220 and anode 215 either directly (as shown) or indirectly (e.g., with exfoliation solution passing radially outward though membrane 220). As mentioned above, exfoliated graphene can exit reaction vessel 105 through graphene suspension outlet 120. Spent exfoliation solution and other by-products can exit reaction vessel 105 through one or both of outlets 120, 125. Anodic lead connection 130 is coupled to anode 215 (not shown). Cathodic lead connection 135 is coupled to cathode 210. The biases applied to anode 215 and cathode 210 via anodic and cathodic lead connections 130, 135 drive the exfoliation of graphene as graphite particles are carried through cathode 210 by flow from graphite suspension inlet 110 to graphene suspension outlet 120.

Cathode 210 is formed of an electrically-conductive porous backbone material that provides multiple uninterrupted electrical paths throughout cathode 210 for biasing graphite particles for exfoliation throughout cathode 210. The porous backbone material includes at least some open-cell pores with pore sizes that permit relevant graphite particles and exfoliated graphene to be carried by the flow of liquid through the pores. Although the pore size of the backbone material and the particle size of the graphite can be varied (e.g., depending on different particle feedstocks and the desired size of the exfoliated graphene), the size of the pores will generally be between 3 and 25 times larger, or between 5 and 10 times larger than the Sauter mean diameter of the particles in a feedstock. For example, to obtain relatively large size graphene flakes, the porous backbone material may have open pores with an average largest dimension in or near the millimeter size range (e.g., 0.5-2 mm) and the graphite particles may have mean diameters ranging between 0.5 and 500 micrometers. The porous backbone material will generally also have a relatively high void volume. For example, void volumes in excess of 50% or in excess of 75% are preferred.

Although cathode 210 is schematically illustrated as generally cylindrical in shape, other shapes (e.g., rectangular or square cuboids, tubular, pyramidal) are possible and may be preferred in certain geometries of electrochemical reactor 100.

In the illustrated implementation, a portion of cathodic lead connection 135 is embedded within and extends longitudinally within cathode 210. This is not necessarily the case. For example, the electrical conductivity of cathode 210 may be sufficient such that an extension of cathodic lead connection 135 is unnecessary. In some implementations, the longitudinally-extending portion of cathodic lead connection 135 can be rod-shaped. In other implementations, the longitudinally-extending portion of cathodic lead connection 135 can have other geometries including, e.g., a woven wire mesh.

Electrical contact between the portions of cathodic lead connection 135 visible in FIG. 1 and the cross-section visible in FIG. 2 can be maintained in a variety of different ways. For example, cathodic lead connection 135 can extend through one end of vessel wall 205 and be insulated from the exfoliation solution until it reaches the interior of cathode 210. The portion of cathodic lead connection 135 that is exposed to exfoliating solution within cathode 210 is typically metallic, although implementations with other conductors (e.g., doped diamond, graphite rod, carbon fiber) are possible. For example, lead connection 135 can be made from copper.

The porous backbone material of cathode 210 is in general chemically compatible with and wetted by the electrolyte used in the electrochemical exfoliation reaction. The porous backbone material of cathode 210 is also generally inert and able to withstand the potentials used in the electrochemical exfoliation reaction and the products and byproducts generated during the reaction. The porous backbone material of cathode 210 is generally mechanically robust enough to withstand the pressures generated by flowing a suspension of graphite particles into cathode 210 and exfoliated graphene out of cathode 210 without breaking.

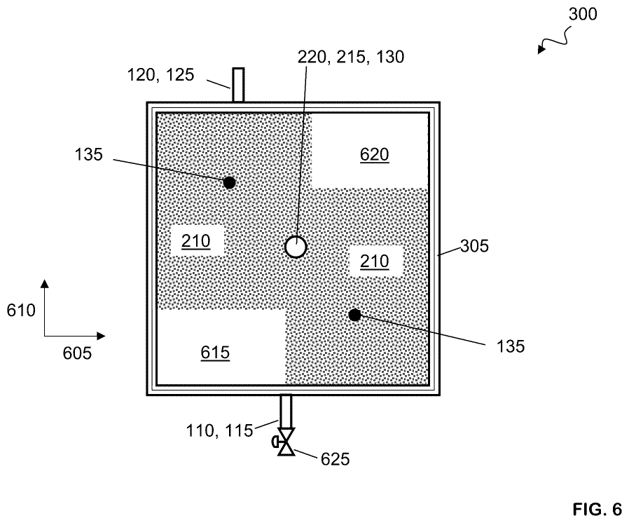

FIG. 4 is a schematic representation of an example porous backbone material 400 that can be used to form cathode 210. As illustrated, porous backbone material 400 forms a three-dimensional network of connected pores that are sufficiently large to allow graphite particles to enter and be driven by liquid flow at least part way therethrough. Thus, porous backbone material 400 has a relatively high void volume.

In some implementations, porous backbone material 400 is a reticulated vitreous carbon (RVC) foam. Vitreous carbon is a non-graphitizing carbon with physical properties that are suitable for use as a porous backbone material 400 in cathode 210. Table 1 below presents typical physical properties of reticulated vitreous carbon foam.

TABLE 1

| Property | Value | |
|---|---|---|
| Compressive Strength | 0.10-0.52 | MPa |
| Tensile Strength | 0.17-0.35 | Mpa |
| Young's Modulus | 102 | Mpa |
| Shear Modulus | 30 | Mpa |
| Specific Heat | 1.26 | J/g · ° C. |
| Thermal Conductivity (bulk) | 0.033-0.050 | W/m · ° C. |
| Electrical Resistivity (bulk) | 32.3 × 10⁻² | ohm · cm |
| Coefficient of Thermal | 2.2 | ppm/° C. |
| Expansion (0-100° C.) | | |

| | |
|---|---|
| Thermal Limits in Air [inert] | 315° C. [3499° C.] |
| Chemical/Corrosion Resistance | Inert to a wide range of |
| | reactive acids, bases, and organic |
| | solvents |

The use of reticulated vitreous carbon foam as porous backbone material 400 in cathode 210 provides some advantages. For example, reticulated vitreous carbon foam is chemically compatible with and wetted by exfoliation electrolyte and able to withstand the exfoliation reaction. Also, reticulated vitreous carbon foam is in general mechanically robust and can be reused many times in the electrochemical exfoliation of graphite. An example of a suitable RVC foam is available under the name DUOCEL® from ERG Aerospace Corporation (Oakland, CA).

Returning to FIGS. 1-3, the illustrated implementation of anode 215 includes three electrically coupled conductive members. In the illustrated implementation in which cathode 210 is generally cylindrical, the members are strip-shaped and disposed radially around cathode 210 with the same longitudinal orientation as cathode 210. This arrangement acts to distribute current flow between cathode 210 and anode 215 more evenly and ensure that exfoliation proceeds relatively uniformly within cathode. However, as mentioned above, cathode 210 can have other shapes and the shape and orientation of anode 215 can be modified correspondingly.

Anode 215 can be made of any of a number of different conductors. For example, doped diamond, diamond-like carbon, and other conductive materials and ceramics are possible. Electrical connection between anodic lead connection 130 and the conductive member(s) of anode 215 can be made in a variety of different ways. For example, electrical conductors can run from anodic lead connection 130, along the outer surface of vessel wall 205, and then through vessel wall 205 to contact the different members of anode 215. As another example, electrical conductors can run within vessel wall 205 itself or (with suitable insulation) through the annular space between the inner surface of vessel wall 205 and the outer surface of membrane 220.

Membrane 220 is thin material that is disposed between cathode 210 and anode 215 and permits the transport of solvent electrolytes and charged species across the membrane while reducing or preventing transport of both graphite particles and exfoliated graphene.

Membrane 220 is generally chemically compatible with and wetted by the electrolyte used in the electrochemical exfoliation reaction. Membrane 220 is generally able to withstand the potentials used in the electrochemical exfoliation reaction and the products and byproducts generated during the reaction. For example, the potentials relative to the opposing anode may be between 0 and −100 volts.

In some implementations, membrane 220 is formed from a material that can be used as a separator membrane in electrochemical energy storage devices. For example, in some implementations, membrane 220 may be a flexible polymeric, carbon fiber, or glass fiber sheet. For example, membrane 220 may be a 200-700 μm thick (e.g., 475 μm thick) quartz fiber sheet with an average pore size of between 0.5 and 1 μm, e.g., approximately 0.7 μm. In some implementations, membrane 220 is a self-supporting membrane and able to maintain its shape even in the absence of an interior member like cathode 210. For example, membrane 220 may be formed of a relatively thin reticulated vitreous carbon foam that has a porosity tailored to hinder or prevent transport of graphite particles and exfoliated graphene.

In the illustrated implementation, membrane 220 is fit close to the outer surface of cathode 210. With such a disposition, membrane 220 can prevent the establishment of flow paths for graphite particles though reaction vessel 105 that do not pass through cathode 210. For example, membrane 220 can be in contact with the outer surface of cathode 210. As a result, graphite particles are kept in at least intermittent electrical contact with cathode 210 as they move within cathode 210 and graphene yield is increased. Also, membrane 220 is relatively further away from anode 215, which contributes to distributing current flow between cathode 210 and anode 215 more evenly.

Membrane 220 can be fit to the outer surface of cathode 210 in different ways. For example, flexible membrane 220 can be wrapped around cathode 210 and fixed. As another example, the size and shape of a self-supporting membrane 220 can be tailored to the size and shape of a cathode 210 that is to be fit into flexible membrane 220. For example, in the illustrated implementation, the inner surface of a self-supporting membrane 220 can define a cylindrically-shaped void that is dimensioned to envelope the cylindrically-shaped cathode 210.

In some implementations, membrane 220 extends between the outlet of graphite suspension inlet 110 within reaction vessel 105 and the inlet of graphene suspension outlet 120 from within reaction vessel 105. For example, membrane 220 can be formed into a tubular shape and coupled directly to a tubular inlet 110 and outlet 120 in a variety of different ways. For example, membrane 220 can be coupled to inlet 110/outlet 120 by a compression fitting or seal or by embedding fibers of membrane 220 within a cast polymeric inlet 110/outlet 120. A direct coupling is not necessarily and, in other implementations, one or more flow channels can be defined within reaction vessel 105 to convey graphite particles from inlet 110 to the cathode 210 within membrane 220 or convey exfoliated graphene from the cathode 210 within membrane 220 to outlet 120.

In some implementations, the longitudinal extent of cathode 210 can match the longitudinal extent of membrane 220. In other implementations, cathode 210 can be shorter than membrane 220.

In the illustrated implementation, inlets 110, 115 and outlets 120, 125 are discrete flowpaths that separately traverse vessel wall 205 and can be implemented using, e.g., separate bulkhead fittings. This is not necessarily the case. For example, in other implementations, a graphite suspension can be mixed with exfoliation solution away from vessel wall 205 and a single flow path that carries the mixture into reactor 100 can act as both graphite suspension inlet 110 and exfoliation solution inlet 115. Similarly, in other implementations, a single flow path that traverses vessel wall 205 can act as both graphene suspension outlet 120 and exfoliation solution outlet 125.

In implementations with discrete flowpaths, the direction of flow can be varied and meaningful results can be achieved. For example, in the illustrated implementation both inlets 110, 115 are—in the illustrated orientation—on the left side of reactor 100 and both outlets 120, 125 on the right. Both graphite suspension and exfoliation solution will thus traverse reactor 100 flowing in the same direction, i.e., from left to right in the illustrated orientation. However, this is not necessarily the case. For example, in some implementations, graphite suspension and exfoliation solution can traverse reactor 100 flowing in opposite directions. As another example, in some implementations, graphite suspension and exfoliation solution can traverse reactor 100 flowing in directions that are perpendicular to one another in a cross-flow arrangement. For example, in the illustrated orientation, graphite suspension can flow from left to right and exfoliation solution can flow from top to bottom between an appropriately repositioned inlet 115 and outlet 125.

In general, the exfoliation reaction will generate gaseous by-products. For example, hydrogen gas will generally be generated at the cathode assembly and the electrolyte may form volatile byproducts. The structure and operation of reactor 100 can be tailored to facilitate removal of such gaseous by-products. For example, in the illustrated implementation, one portion of exfoliation solution outlet 125 is positioned in the vicinity of the top of reaction vessel 105 and may preferentially release gaseous by-products from the reaction vessel 105. Another portion of exfoliation solution outlet 125 may be positioned at a lower level and preferentially allow liquid exfoliation solution (and liquid by-products) to exit reaction vessel 105.

In other implementations, the shape of reaction vessel 105 is tailored to gather gaseous by-products for outlet from reaction vessel 105. For example, rather than flat top surface, the top surface of reaction vessel 105 can be sloped so that gaseous by-products gather at the highest point for outlet from reaction vessel 105 by an exfoliation solution outlet 125 at this position.

In yet another implementation, gaseous by-products may be vented from the reaction vessel 105 via one or more one-way pressure relief valves.

In operation, the rate of flow of graphite suspension and exfoliation solution into and out of reactor 100 can be tailored, e.g., to the characteristics of the feedstock, the applied potentials, and other parameters like temperature and the rate of transport of graphite particles and graphene through cathode 210, and the rate of gaseous by-products generated that lead to pressurization of reaction vessel 105. However, in general, it is desirable that the exfoliation reaction yield per time be high. In some implementations, the mass flow rate of graphite suspension into reaction vessel 105 at inlet 110 can be tailored such that the total time any single graphite particle interacts with the porous backbone of the cathode within the reaction zone of reactor 105 is at least equivalent to the total reaction time necessary to achieve a 60% yield, a 70% yield, or an 80% yield of exfoliated product as the product exits the reactor at the outlet 120. In some implementations, the mass flow rate of graphite suspension into reaction vessel 105 is tailored such that the total time any single graphite particle interacts with the porous backbone of the cathode within the reaction zone of reactor 105 is equal to or greater than to the total reaction time necessary to achieve a maximum yield of exfoliated graphite. The total elapsed time through the tortuous path is now referred to as the residence time of the continuous-flow reactor for the exfoliation of graphite. The residence time of such a continuous-flow reactor is a function of factors like, e.g., mass flow rate, the effective viscosity of the suspension, temperature, pressure drop across the inlet and outlet of the reactor and, importantly, the paths along which graphite particles traverse cathode 210. The tortuosity of the paths through cathode 210 is a function of the cathode's geometric properties, such as volume, aspect ratio, and porosity. Model simulations, such as those based on Computational Fluids Dynamics (CFD) or the Lattice Boltzmann Method (LBM), can be used to tailor residence time a priori for different geometries of reactor 105.

In some implementations, the residence time or other parameters are actively controlled during a continuous production process. For example, dynamic light scattering or other techniques can be used to monitor the solution that flows through graphene suspension outlet 120 for graphite particles that are not fully exfoliated. Among the other parameters that can be actively controlled are the concentration of graphite particles in the graphite suspension, the concentration of salts in the exfoliation solution, the residence time or concentration of the exfoliation solution, the effective viscosity of the suspension, and the potential difference between the anode and the cathode.

In general, the solvent in which the graphite particles are suspended is also used in the exfoliation solution. However, in some implementations, the graphite particles can be suspended in a solvent that differs from the solvent of the exfoliation solution. In some implementations, the graphite suspension can include between 0.5 wt % and 50 wt % particles in the solvent. Example solvents include propylene carbonate [C₄H₆O₃], ethylene carbonate, or dimethyl carbonate. In general, the solvent in which the graphite particles are suspended will be degassed or passed through a gas bubbler to replace oxygen with and unreactive gas such as, e.g., argon or nitrogen.

In some implementations, the exfoliation solution can include a salt composed of large ions, such as tetrabutylammonium hexafluorophospate, tetrabutylammonium hexafluoroborate, tetrabutylammonium bis(trifluromethanesulfonyl)imide or N-benzyl-N,N,N-trimethylammonium hexafluorophosphate, dissolved in an organic carbonate solvent, such as propylene carbonate, ethylene carbonate, or dimethyl carbonate. Concentrations of these exemplary salt solutions may range between 0.01 and 0.5 M.

FIG. 5 is a schematic representation of an electrochemical reactor system 200 that can be used in the continuous production of graphene flakes by electrochemical exfoliation. In the illustrated implementation, reactor system 200 includes two instances of reactor 100,100′ that are coupled in series such that the graphene suspension outlet 120 of the upstream reactor 100 is coupled to the graphite suspension inlet 110′ of the downstream reactor 100′.

In the illustrated implementation, the upstream graphene suspension outlet 120 is directly coupled to the downstream graphite suspension inlet 110′ such that all of the fluid that passes through the upstream graphene suspension outlet 120 enters the downstream graphite suspension inlet 110′. This is not necessarily the case.

For example, in some implementations, one or more mechanisms can be used to concentrate exfoliated graphene and graphite particles that are not fully exfoliated in the solution that enters the downstream graphite suspension inlet 110′. For example, solvent can be filtered from the suspension to concentrate exfoliated graphene and graphite particles.

As another example, in some implementations, one or more mechanisms can be used to separate exfoliated graphene and graphite particles that are not fully exfoliated. For example, a centrifugal separator can be used to concentrate graphite particles for exfoliation in downstream reactor 100′. In another example, a Field Flow Fractionation (FFF) device may be employed to separate multiple fractions of exfoliated product having differing densities or particle sizes (or both).

In some implementations, the reaction conditions are nearly the same in upstream and downstream reactors 100, 100′. This is not necessarily the case. For example, in some cases, the residence time, the exfoliation solutions, the applied voltages, and/or the characteristics of cathode may differ in reactors 100, 100′. The differences may be tailored to the difference between the graphite particles than enter reactors 100, 100′ via their respective graphite suspension inlets 110, 110′. For example, the cathode in downstream reactor 100′ may have smaller pores that the cathode in upstream reactor 100.

FIG. 6 is a schematic representation of a side view of an electrochemical reactor system 300 that can be used in the continuous production of graphene flakes by electrochemical exfoliation. Reaction vessel 305 of reactor system 300 defines a vertically-oriented but flattened interior volume that helps retain unreacted graphite particles within vessel 305.

In more detail, the interior volume of reaction vessel 305 has a first dimension 605, a second dimension 610, and a third dimension. In the illustrated representation from the side, first dimension 605 extends leftward and rightward, second dimension 610 extends upward and downwards, and third dimension extends into and out of the page. Dimensions 605, 610 are larger than the third dimension and the interior volume of reaction vessel 305 is flattened with respect to vertical. For example, the third dimension of reaction vessel 305 can be between 5% and 20% of the shorter of dimensions 605, 610.

In the illustrated implementations, the top, bottom, left, and right sides of reaction vessel 305 are approximately equal in length, linear, and intersect at right angles. None of these is necessarily the case. For example, in some implementations, the sides can have different lengths. The sides can be rounded or otherwise depart from linearity. Also, the sides can intersect at different angles. In some cases, implementations can include combinations of such departures from the illustrated characteristics. For example, top, bottom, left, and right sides can have different lengths and can be rounded with different curvatures. The intersections of the sides can also be rounded.

In addition to reaction vessel 305, electrochemical reactor system 300 includes a combined particle suspension/exfoliation solution inlet 110, 115 and a combined graphene suspension/exfoliation solution outlet 120, 125. Combined inlet 110, 115 is at the bottom of reaction vessel 305, whereas combined outlet 120, 125 is at the top of reaction vessel 305. The flow path for graphite, graphene, exfoliation solution, and other by-products through reaction vessel 305 passes generally vertically through reaction vessel 305. The verticality of the flow path helps retain unreacted or incompletely-reacted graphite particles in reaction vessel 305 while allowing exfoliated graphene to exit vessel 305.

Further, combined inlet 110, 115 includes a control valve 625. Control valve 625 can be used to tailor the flow of solution into reaction vessel 305—and hence the time that graphite particles interact with the porous backbone of cathode 210 within the reaction zone of reactor 105.

In the illustrated implementation, cathode 210 also has a flattened volume with cathode 210 being larger in dimensions 605, 610 than in the third dimension. As before, cathode 210 is formed of an electrically-conductive porous backbone material that provides multiple uninterrupted electrical paths. Cathode 210 is in close fit to at least some portion of the interior walls of reaction vessel 305 such that the establishment of flow paths for graphite particles that do not pass through cathode 210 is prevented. In the illustrated implementation, cathode 210 is in close fit with only a portion of interior side walls, top wall, and bottom wall of reaction vessel 305. Cathode 210 is also in close fit with the vertical walls that bound vessel 305 in the third dimension. Since cathode 210 is in close fit with only a portion of the interior walls of reaction vessel 305, cathode 210 and the walls of vessel 305 define interior manifold-like volumes 615, 620 within vessel 305 in which the porous backbone material of cathode 210 does not impede transport. Manifold-like volume 615 is at the bottom of vessel 305 and allows particles and solution that enter through combined inlet 110, 115 to distribute over a relatively larger portion of cathode 210. Manifold-like volume 620 is at the top of vessel 305 and can, e.g., collect gaseous by-products generated by the exfoliation reaction or can allow particles and/or solution that enters through a second combined inlet (not shown) to distribute. For example, an approximately cross-flow arrangement can be achieved. In some implementation, a pressure relief valve can be coupled to manifold-like volume 620 to exhaust the gaseous by-products. Alternatively or additionally, one or more pressure relief valves can also be coupled to combined inlet 110, 115 and/or combined outlet 120, 125.

In the illustrated implementation, anodic and cathodic lead connections 130, 135 extend through the vertical walls that bound vessel 305 in the third dimension. In the illustrated implementation, reactor system 300 includes a pair of spaced-apart cathodic lead connections 135 that are both electrically coupled to cathode 210. Multiple cathodic lead connections 135 help ensure that the exfoliation voltage is maintained across cathode 210.

Anodic connection 130 is coupled to an anode 215 that is positioned near the middle of the area of the vertical walls that bound vessel 305 in the third dimension. Membrane 220 is sealed to an inside wall of vessel 305 around the periphery of anode 215 to separate cathode 210 and anode 215.

A number of implementations have been described. Nevertheless, it will be understood that various modifications may be made. Accordingly, other implementations are within the scope of the following claims.

What is claimed is:

1. A method for the continuous production of graphene, the method comprising:
flowing a suspension of graphite particles into a conductive, open-cell porous material that is disposed within a reaction vessel;
applying a cathodic potential to the conductive, open-cell porous material, wherein the cathodic potential suffices to exfoliate graphene; and
flowing a suspension of the exfoliated graphene out from the conductive, open-cell porous material.

2. The method of claim 1, wherein a membrane is fit to an outer surface of the conductive, open-cell porous material tightly enough to prevent establishment of a flow path for the graphite particles that does not pass through the conductive, open-cell porous material.

3. The method of claim 2, wherein the membrane permits transport of the electrolyte salt but hinders or prevents transport of the exfoliated graphene and is disposed between the conductive, open-cell porous material and an anode during the application of the cathodic potential.

4. The method of claim 2, wherein the membrane has an average pore size of between 0.5 and 1 μm.

5. The method of claim 1, wherein an anode that includes multiple members is in electrical contact with fluid in the reaction vessel, wherein the members are spatially distributed about the conductive, open-cell porous material.

6. The method of claim 1, wherein a residence time of material within the conductive, open-cell porous material is between 1 and 600 minutes.

7. The method of claim 1, wherein the pores in the porous backbone material are generally between 3 and 25 times larger, or between 5 and 10 times larger than a Sauter mean diameter of the graphite particles.

8. The method of claim 1, wherein the porous backbone material has a void volume in excess of 50%, for example, in excess of 75%.

9. The method of claim 1, wherein the porous backbone material is reticulated vitreous carbon foam.

10. The method of claim 1, wherein the cathodic potential is applied relative to a doped-diamond anodic electrode.

11. The method of claim 1, wherein the cathodic potential is in excess of −40 volts.

12. The method of claim 1, wherein an average largest dimension of pores in the conductive, open-cell porous material is between 0.5-2 mm and the graphite particles have mean diameters ranging between 0.5 and 500 micrometers.

13. The method of claim 1, wherein the graphite particles are suspended in propylene carbonate.

14. The method of claim 1, further comprising flowing an exfoliation solution that comprises an organic solvent and a supporting electrolyte salt into the reaction vessel.

15. The method of claim 14, wherein:
the organic solvent is propylene carbonate, ethylene carbonate, or dimethyl carbonate; and
the electrolyte salt is tetrabutylammonium hexafluorophospate, tetrabutylammonium hexafluoroborate, tetrabutylammonium bis(trifluromethanesulfonyl)imide, or N-benzyl-N,N,N-trimethylammonium hexafluorophosphate.

16. The method of claim 1, further comprising flowing reaction by-products out from the reaction vessel via an outlet that differs from an outlet via which the suspension of the exfoliated graphene flows out from the reaction vessel.

17. The method of claim 1, further comprising:
flowing the exfoliated graphene out from the reaction vessel;
flowing a liquid that carries the exfoliated graphene out from the reaction vessel into a second conductive, open-cell porous material; and
applying a cathodic potential to the second conductive, open-cell porous material, wherein the cathodic potential suffices to exfoliate graphene.

18. The method claim 1, further comprising separating exfoliated graphene from the liquid that carries the exfoliated graphene out from the reaction vessel before flowing the liquid into the second conductive, open-cell porous material.

19. An electrochemical reactor for the production of graphene, the reactor comprising:
an anode;
a reticulated vitreous carbon foam cathode; and
a membrane disposed between the reticulated vitreous carbon foam cathode and the anode, wherein the membrane is configured to prevent transport of graphite particles but permit transport of electrolytes and organic solvent of a solution for exfoliation of graphite.

20. The electrochemical reactor of claim 19, wherein the membrane is fit close enough to an outer surface of the cathode to prevent the establishment of flow paths for graphite particles that do not pass through the cathode.

21. The electrochemical reactor of claim 19, wherein the membrane is in contact with an outer surface of the cathode.

22. The electrochemical reactor of claim 19, further comprising a graphite suspension inlet fluidically coupled to provide suspended graphite particles to the cathode.

23. The electrochemical reactor of claim 19, further comprising an active control configured to control a parameter of electrochemical exfoliation of graphene.

24. The electrochemical reactor of claim 19, wherein an average largest dimension of pores in the reticulated vitreous carbon foam is between 0.5-2 mm.

25. The electrochemical reactor of claim 19, further comprising a suspension of graphite particles and a pump configured to pump the suspension of graphite particles through the reticulated vitreous carbon foam cathode.

26. The electrochemical reactor of claim 25, wherein a residence time of the pumped suspension within the reticulated vitreous carbon foam is between 1 and 600 minutes.
